(19) United States
(12) Patent Application Publication
(10) Pub. No.: US 2006/0285428 A1
(43) Pub. Date: Dec. 21, 2006

(54) Mixing bowl with suction devices

(76) Inventors: Charles S. Paradise, New York, NY (US); Christopher M. Mellen, New York, NY (US); Louis F. Henry, Scarsdale, NY (US)

Correspondence Address: LATHROP & GAGE LC, 2345 GRAND AVENUE, SUITE 2800, KANSAS CITY, MO, 64108, US

(21) Appl. No.: 11/239,921

(22) Filed: Sep. 30, 2005

Related U.S. Application Data
(63) Continuation-in-part of application No. 29/232,222, filed on Jun. 16, 2005.
(63) Continuation-in-part of application No. 29/232,229, filed on Jun. 16, 2005.
(63) Continuation-in-part of application No. 29/232,215, filed on Jun. 16, 2005.
(63) Continuation-in-part of application No. 29/232,220, filed on Jun. 16, 2005.
(63) Continuation-in-part of application No. 29/232,225, filed on Jun. 16, 2005, now Pat. No. D530989.
(63) Continuation-in-part of application No. 29/232,321, filed on Jun. 16, 2005, now Pat. No. D519802.
(63) Continuation-in-part of application No. 29/232,217, filed on Jun. 16, 2005, now Pat. No. D530992.
(63) Continuation-in-part of application No. 29/232,271, filed on Jun. 16, 2005.
(63) Continuation-in-part of application No. 29/232,218, filed on Jun. 16, 2005.
(63) Continuation-in-part of application No. 29/232,248, filed on Jun. 16, 2005.
(63) Continuation-in-part of application No. 29/232,226, filed on Jun. 16, 2005.
(63) Continuation-in-part of application No. 29/232,228, filed on Jun. 16, 2005, now Pat. No. D521287.

(51) Int. Cl. A47J 47/00

(52) U.S. Cl. 366/130

(57) ABSTRACT

A mixing bowl assembly having a mixing bowl and a base to receive the mixing bowl. The base contains two suction devices. One of the suction devices secures the mixing bowl to the base. The other suction device secures the base to a counter or work surface. The mixing bowl may be secured to the base at various selected angles to facilitate the mixing of different types of ingredients. Each suction device is secured to its respective mating surface by moving a handle to activate the suction device. Each suction device is deactivated by moving the handle in the opposite direction to release the suction device from the surface to which it was adhered or mated.

### RELATED APPLICATIONS

This application is a continuation-in-part of U.S. patent application Ser. No. 29/232,222, filed Jun. 16, 2005; U.S. patent application Ser. No. 29/232,229, filed Jun. 16, 2005; U.S. patent application Ser. No. 29/232,215, filed Jun. 16, 2005; U.S. patent application Ser. No. 29/232,220, filed Jun. 16, 2005; U.S. patent application Ser. No. 29/232,225, filed Jun. 16, 2005; U.S. patent application Ser. No. 29/232,321, filed Jun. 16, 2005; U.S. patent application Ser. No. 29/232,217, filed Jun. 16, 2005; U.S. patent application Ser. No. 29/232,271, filed Jun. 16, 2005; U.S. patent application Ser. No. 29/232,218, filed Jun. 16, 2005; U.S. patent application Ser. No. 29/232,248, filed Jun. 16, 2005; U.S. patent application Ser. No. 29/232,226, filed Jun. 16, 2005; and U.S. patent application Ser. No. 29/232,228, filed Jun. 16, 2005. The aforementioned applications are incorporated herein by reference.

### FILED OF INVENTION

The field of the invention is mixing bowls for use in a kitchen. Specifically, the field of the invention is a mixing bowl assembly that has a base suction device that can be securely mounted to a counter or work surface and a bowl suction device that holds the bowl at any angle desired by the person using the bowl.

### BACKGROUND AND PRIOR ART

Mixing bowls are commonly used to mix food ingredients as part of the cooking process. Ingredients may be mixed before they are placed in a cooking pan for baking or before they are placed in a serving dish and served for consumption.

Some ingredients, such as liquids, are relatively easy to mix, while others, such as cold or chunky foods, are more difficult to mix. Other ingredients must be added gradually while mixing is in progress. An example is flour, which must frequently be added gradually to a relatively smaller amount of liquid, such as milk, and other ingredients such as sugar or butter.

When different types of food are mixed, it is often necessary to position the bowl to better accommodate the ingredient being added. For example, sifting flour usually requires an upright bowl, whereas, beating an egg is more easily done in an angled bowl. If the bowl must be angled, either to accommodate the type of ingredient being added or for the comfort of the person who is doing the mixing, the cook must hold the bowl in one hand at the desired angle and mix with the other hand.

Further, if an ingredient must be added as mixing is taking place, it is often necessary to angle the bowl with one hand to properly or comfortably add the ingredient to the mix with the other hand. Then, while either keeping a grip on the bowl or changing the bowl angle with the hand gripping the bowl, the cook must, with the other hand, place the container on the work surface and pick up the mixing spoon or electric mixer to continue the mixing process.

If the person who is doing the mixing does not keep a grip on the bowl during the mixing process, the bowl may be at an inappropriate angle for effective mixing, or the bowl may tip or move during mixing. Similarly, if the mixing process is done with the bowl at an inappropriate angle, the contents of the bowl may spill, splash, or otherwise be ejected from the bowl during the mixing process. Such spills are common when liquids or ingredients of different sizes or different liquid/solid consistency are being mixed. Similarly, if one must mix ingredients vigorously—e.g., an egg or cream until stiff—it is especially important to keep the bowl steady and at the proper angle, lest the contents are spilled or the mixing does not allow the ingredient to reach the desired constancy as a result of the mixing.

Prior art bowls have used various devices or structures to attempt to solve, or at least ease, these problems for the cook. For example, Tardiff U.S. Pat. No. 5,423,452 shows gripping treads or lugs on the bottom of the bowl. Morris U.S. Pat. Nos. 5,634,617 and 5,813,638, show the use of a stand for the bowl. Lauer et al U.S. Pat. No. 6,688,485 shows a bowl tilted in a base. Tieffel et al. U.S. Pat. No. D364,546 shows a bowl stand with attachers at the top of the stand. And, Heiberg et al, U.S. Pat. No. 5,169,023 shows spaced ribs on the side of the bowl.

Devices or structures such as those shown in the prior art tend to resist movement of the bowl on the work surface or make it easier to keep the bowl at certain angle. However, even these devices and structures require hand control by the person doing the mixing and are frequently unstable both on the stand or base on which they are set and at the angle at which the bowl is to be kept. None of them show a secure attachment of the base or bowl to the work surface. Only Tieffel shows a means for secure attachment of the bowl to the base. None of these prior art devices or structures discloses a secure, firm attachment of both the bowl to the base and the base to the work surface. Thus, these prior art devices merely mitigate the difficulties associated with mixing and mixing bowls. They do not substantially resolve solve those difficulties.

### SUMMARY OF INVENTION

The mixing bowl assembly of the invention has comprises a base and a bowl. The bottom of the bowl is rounded and generally hemispherical.

The base comprises a lower portion, an upper portion, at least one side, a bottom, a top, an interior chamber, a top opening, and a bottom opening. The side or sides of the base also form elongated horizontal slots, one below the top opening of the base and the other above the bottom opening of the base. The bottom of the base is substantially flat. The top of the base is concave and is shaped to receive the rounded or hemispherical bottom of the bowl.

The interior chamber houses two suction devices—i.e., a counter suction device and a bowl suction device. The counter suction device is associated with and operated through the opening in the bottom of the base. The bowl suction device is associated with and operates through the opening in the top of the base.

The counter suction device comprises a suction pad, a suction pad plate, a handle, and a pivot. Two spaced-apart bridge-like structures extend away from a side of the plate. Each bridge-like structure has an underside that is ramped or sloped. The pivot is situated between the bridge-like structures. The handle extends from the underside of one of the bridge-like structures, through the pivot, along the underside of the other bridge-like structure, and outward thorough the elongated slot above the bottom opening of the base. The handle, so situated, is in sliding contact with the sloped undersides of the bridge-like structures. The suction pad is attached to the side of the plate from which the bridge-like structures extend; however, the suction pad is larger than the plate and extends outward from and beyond the perimeter or circumference of the plate. The counter suction device is oriented so that the part of the suction pad that extends outward from the plate makes contact with the counter or work surface through the bottom opening of the base.

The bowl suction device is constructed substantially the same as the counter suction device. However, the bowl suction device and its suction pad are oriented in the chamber of the base such that the part of the suction pad that extends outward from the plate makes contact with the hemispherical or rounded bottom of the bowl through the top opening of the base. The handle of the bowl suction device extends outward thorough the elongated slot below the top opening of the base.

The suction devices are described in additional detail in the co-pending application of inventors Charles S. Paradise and Louis F. Henry.

Each suction device is operated by moving its handle from one side of its elongated slot to the other. Movement of the handle in one direction causes the handle to slide along the sloped undersides of the bridge-like structures. As the handle slides along the slope underside, it pulls the plate from which the bridge-like structures extend, in turn causing the plate to pull the central portion of the suction pad away from the surface with which it was in contact, while the outer portion of the suction pad remains in contact with that surface. As the central portion of the suction pad is pulled away from the surface, the air pressure between the suction pad and that surface decreases, creating a partial vacuum under the central portion of the suction pad, which, in turn causes the outer portion of the suction pad, which is still in contact with the surface, to adhere to the surface.

If the handle of the bowl suction device is so moved, the suction pad is adhered to the bowl, preventing the bowl from moving. Movement of the handle in the opposite direction in the slot relaxes the central portion of the suction pad and allows the suction pad to be easily removed from the surface to which it was formerly mated.

As will be appreciated from the above description, the counter suction device permits the base of the mixing bowl assembly to be firmly secured to the work surface or counter on which bowl assembly is placed. Similarly, the bowl suction device permits the bottom of the bowl to be firmly secured to the bowl suction pad. And, since the bottom of the bowl is rounded or hemispherical, the bowl may be firmly secured to the bowl suction pad at various orientations and angles.

The inventive mixing bowl assembly may be operated in different ways. The base may be secured or adhered to the counter by the suction pad while the bowl, when not adhered to its suction pad, may be moved and oriented at different angles or positions with respect to the base and work surface. The bowl may be secured or adhered to its suction pad while the based is not adhered to the counter by its suction pad. And, both the bowl and base may be secured to their respective suction pads, fixing both in their respective positions on the base and the counter. Of course, the bowl may also be secured at various angles and orientations with respect to the base and the counter by placing the bowl in its desired position and moving the bowl handle to cause the suction pad to adhere to and fix the bowl in that position.

Thus, one may fix the bowl at a desired position and still move the base and bowl to different positions; one may secure the base to the counter and move the bowl to a desired position; one may secure the bowl to the base and the base to the counter at the same time; or one may leave both base and bowl unsecured and moveable. Ingredients may be added to the bowl, mixed in the bowl, or added and mixed simultaneously in any of the described configurations of the bowl and base, allowing the cook or operator maximum flexibility in positioning and orienting the base and bowl, respectively.

The various permitted orientations of the bowl also allow ingredients to be added to a bowl fixed at a desired angle, allow ingredients to be mixed in the bowl while the bowl is fixed at an optimum angle for such mixing, allow the base and attached bowl to be moved without changing or disturbing the angle or orientation of the bowl, and allow the operator or cook to add and mix ingredients with both hands at the same time without having to hold on to or tend the bowl or base at all.

### BRIEF DESCRIPTION OF DRAWINGS

FIG. 1 is a perspective view of the inventive bowl assembly showing a bowl positioned on a base of the assembly.

FIG. 2 is a cross section of the bowl assembly of FIG. 1 showing two suction devices in an internal chamber of the base.

FIG. 3 is an exploded side view of the bowl and the base of the bowl assembly with the bowl raised above the base.

FIG. 4 is a side view of the bowl and base similar to that of FIG. 3, but showing the bowl seated in the base at an angle with respect to the base.

FIG. 5 is a side view of the bowl and base similar to that of FIG. 4 showing the bowl seated in the base at a different angle with respect to base.

### DETAILED DESCRIPTION

Certain terminology will be used in the following description. Words such as “top”, “bottom”, “upper”, “lower”, “upward”, “downward”, “rightward”, “leftward”, “above”, “below”, and the like, refer to those same directions in the properly oriented drawings. Words such as “inward”, “outward”, “inner”, “outer”, “central”, refer to the same directions or locations at, toward, or away from the geometric center of the object shown or referenced in the properly oriented drawings. This use of such terminology is for convenient reference, is not intended to be limiting (as, for example, if an embodiment of the invention is inverted or reversed), and includes the words specifically mentioned, derivatives thereof, and words of a similar nature or import.

Mixing Bowl Assembly

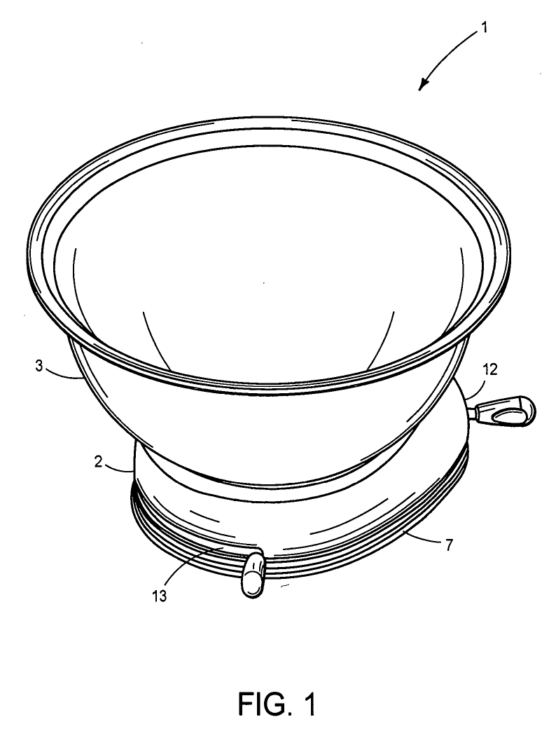

As shown in FIG. 1, the mixing bowl assembly 1 of the invention comprises a base 2 and a bowl 3. As best shown in FIG. 3, a bottom 5 of the bowl 3 is rounded and generally hemispherical.

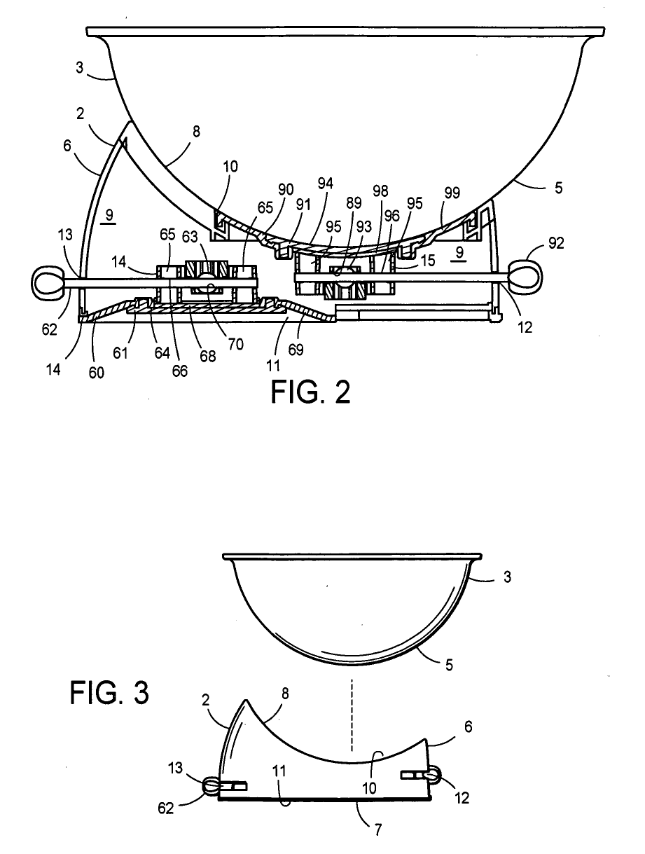

As best shown in FIG. 3, the base 2 comprises at least one side 6, a bottom 7, a top 8, an interior chamber 9 (see FIG. 2), a top opening 10, and a bottom opening 11. As shown in FIG. 2, the side or sides 6 of the base 2 also form elongated horizontal slots 12 and 13. Slot 12 is formed in the side 6 of the base 2 below the top opening 10 of the base 2; slot 13 is formed in the side 6 of the base 2 above the bottom opening 11 of the base 2. The bottom 7 of the base 2 is substantially flat. The top 8 of the base 2 is concave and is shaped to receive the rounded or hemispherical bottom 5 of the bowl 3.

As shown in FIG. 2, the interior chamber 9 contains two suction devices—i.e., a counter suction device 14 and a bowl suction device 15. The counter suction device 14 is associated with and operated through the bottom opening 11 in the base 2. The bowl suction device 15 is associated with and operates through the top opening 10 of the base 2.

Counter Suction Device

As shown in FIG. 2, The counter suction device 14 comprises a suction pad 60, a suction pad plate 61, a handle 62, and a pivot 63. The suction plate 61 has a top side 64. Two spaced-apart bridge-like structures 65 extend away and outward from the top side 64 of the plate 61. Each bridge-like structure 65 has an underside 66 that is ramped or sloped. The pivot 63 is situated between the bridge-like structures 65.

The suction pad 60 is larger in diameter than the suction pad plate 61. The suction pad 60 has a central portion 68 and an outer portion 69. When the suction pad 60 is placed on the top side 64 of the suction pad plate 61, the outer portion 69 of the suction pad 60 extends beyond and outward from the suction pad plate 61. The central portion 68 of the suction pad 60 is situated on and connected to the top side 64 of the plate 61.

The handle 62 extends from the sloped underside 66 of one of the bridge-like structures 65, through a hole 70 in the pivot 63, along the sloped underside 66 of the other bridge-like structure 65, and outward thorough the elongated slot 13 in the side 6 of the base 2 above the bottom opening 11 of the base 2. The handle 62, so situated, is in sliding contact with the sloped undersides 66 of the bridge-like structures 65.

The counter suction assembly 14 is oriented so that the outer portion 69 of the suction pad 60, which extends outward from the plate 61, makes contact with the counter or work surface through the bottom opening 11 of the base 2.

Operation of Counter Suction Device

The counter suction device 14 is operated by moving its handle 62 from one side of its elongated slot 13 to the other. Movement of the handle 62 in one direction causes the handle 62 to slide along the slopes of the undersides 66 of the bridge-like structures 65. The slopes of the undersides 66 are oriented so that, as the handle 62 is moved in one direction, the handle 62 forces or pulls the plate 61 away from the counter or work surface.

Thus, as the handle 62 slides along the sloped underside 66, it pulls the plate 61 from which the bridge-like structures 65 extend away from the counter, in turn causing the plate 61 to pull the central portion 68 of the suction pad 60 away from the surface of the counter, while the outer portion 69 of the suction pad 60 remains in contact with the surface of the counter. As the central portion 68 of the suction pad 60 is pulled away from the surface, the air pressure between the suction pad 60 (and the plate 61, which is beneath a part of the pad 60) and the counter surface decreases, creating a partial vacuum under the central portion 68 of the suction pad 60, which, in turn causes the outer portion 69 of the suction pad 60, which is still in contact with the counter, to adhere to the counter. If the handle 62 of the counter suction device 14 is so moved in slot 13, the suction pad 60 is adhered to the counter, preventing the base 2 from moving.

When the counter suction device 14 is engaged, as described above, there is a force on the suction pad 60 caused by the partial vacuum that tends to pull the suction pad 60 toward the surface to which it is adhered. There is also a force generated by the stretching of the rubber (or other flexible) suction pad as it is pulled upward, urging the plate and suction pad toward the surface to which it is adhered. These forces are resisted by the handle 62, which holds the suction pad 60 (and the suction pad plate 61) in position via its contact with the bridge-like structures 65. (The resistance of the handle may be assisted by the inclusion of lock indentations described below.)

When the handle 62 is moved in the opposite direction (i.e., in a direction in the elongated slot 13 opposite from the direction described above to engage the suction device 14), the handle slides in the opposite direction along the sloped undersides 66 of the bridge-like structures 65, the suction pad 60 relaxes, and the suction plate 61 is allowed to move toward the surface to which it is adhered, which reduces the partial vacuum (increases the pressure between the suction plate 61 and the surface to which the suction device 14 is adhered). When the partial vacuum has been so reduced, the suction pad 60 is no longer adhered to the surface, and the counter suction device 14 can be easily removed from the surface to which it formerly secured.

Bowl Suction Device

As shown in FIG. 2, the bowl suction device 15 is constructed substantially the same as the counter suction device, except that it is oriented in the chamber 9 of the base 2 such that the suction device 15 makes contact with bottom or lower portion 5 of the bowl 3 through the top opening 10 of the base 2, instead of the counter or other surface on which the mixing bowl assembly 1 is placed.

Specifically, as shown in FIG. 2, the bowl suction device 15 comprises a suction pad 90, a suction pad plate 91, a handle 92, and a pivot 93 having a hole 89 therethrough. The suction plate has a top side 94. Two spaced-apart bridge-like structures 95 extend away and outward from the top side 94 of the plate 91. Each bridge-like structure 95 has an underside 96 that is ramped or sloped. The pivot 93 is situated between the bridge-like structures 95.

The suction pad plate 91 is curved to fit the configuration (rounded in FIG. 2) of the bottom 5 of the bowl 3. If it is desired to use other configurations of the bottom 5 of the bowl 3—i.e., flatter, more curved, or differently curved—the plate 91 may be so shaped and configured. The suction device 15 will work on the bowl as long as the edge or outer portion 99 of the suction pad 90 makes contact with the bottom 5 of the bowl 3; however, a greater area of contact between the bottom 5 of the bowl 3 and the suction pad 90 will strengthen the mating contact between the bowl 3 and the suction device 15 when the suction device 15 is activated. Thus, it is desirable to shape the suction plate 91 to fit the configuration of the bottom 5 of the bowl 3.

The suction pad 90 is larger in diameter than the suction pad plate 91. The suction pad has a central portion 98 and an outer portion 99. When the suction pad 90 is placed on the top side 94 of the suction pad plate 91, the outer portion 99 of the suction pad 90 extends beyond and outward from the suction pad plate 91. The central portion 98 of the suction pad 90 is situated on and connected to the top side 94 of the plate 91.

The handle 92 extends from the sloped underside 96 of one of the bridge-like structures 95, through a hole 89 in the pivot 93, along the sloped underside 96 of the other bridge-like structure 95, and outward thorough the elongated slot 12 in the side 6 of the base 2 below the top opening 10 of the base 2. The handle 92, so situated, is in sliding contact with the sloped undersides 96 of the bridge-like structures 95.

Operation of Bowl Suction Device

The operation of the bowl suction device 15 is substantially similar to the operation of the counter suction device 14 described above.

The bowl suction device 15 is operated by moving its handle 92 from one side of its elongated slot 12 to the other. Movement of the handle 92 in one direction causes the handle 92 to slide along the upward slopes of the underside 96 of the bridge-like structures 95. The slopes of the undersides 96 are oriented so that, as the handle 92 is moved in one direction, the handle 92 forces or pulls the plate 91 away from the bottom 5 of the bowl 3.

As the handle 92 slides along the sloped undersides 96, it pulls the plate 91 from which the bridge-like structures 95 extend, in turn causing the plate 91 to pull the central portion 98 of the suction pad 90 away from the bottom 5 of the bowl 3, while the outer portion 99 of the suction pad 90 remains in contact with the bottom 5 of the bowl 3. As the central portion 98 of the suction pad 90 is pulled away from the bottom 5 of the bowl 3, the air pressure between the suction pad 90 (and the plate 91, which is beneath a part of the pad 90) and the bottom 5 of the bowl 3 decreases, creating a partial vacuum under the central portion 98 of the suction pad 90, which, in turn causes the outer portion 99 of the suction pad 90, which is still in contact with the bottom 5 of the bowl 3, to adhere to the bottom 5 of the bowl 3. If the handle 92 of the bowl suction device 15 is so moved in the slot 12, the suction pad 90 is adhered to the bottom 5 of the bowl 3, preventing the bowl 3 from moving.

The slopes of the undersides 96 of the bridge-like structures 95 are oriented so that, as the handle 92 is moved in the opposite direction (i.e., a direction opposite of that described immediately above) along the sloped undersides 96, the suction pad 90 relaxes and the plate 91 is allowed to move back toward the bottom 5 of the bowl 3, reducing the partial vacuum. Thus, movement of the handle 92 in the opposite direction in the slot 12 allows the suction pad 90 to be easily removed from the bottom 5 of the bowl 3 to which it is was formerly mated.

Operation of the Mixing Bowl Assembly

As will be appreciated from the above description, the counter suction device 14 of the mixing bowl assembly 1 permits the base 2 of the mixing bowl assembly 1 to be firmly secured to the work surface or counter on which bowl assembly 1 is placed. Similarly, the bowl suction device 15 permits the bowl suction device 15 to be firmly secured to the bottom 5 of the bowl 3. And, since the bottom 5 of the bowl 3 is rounded or hemispherical, the bowl 3 may be firmly secured to the bowl suction device 15 at various orientations and angles.

The mixing bowl assembly may be operated in many different ways.

The base 2 may be secured or adhered to the work surface by the counter suction device 14 while the bowl 3, when not adhered the bowl suction device 15, may be moved and oriented at different angles or positions with respect to the both the base 2 and the work surface. The bowl 3 may be secured or adhered to the bowl suction device 15, while the base 2 is not adhered to the counter by the counter suction device 14. Further, both the bowl 3 and the base 2 may be secured to their respective suction devices 15 and 14, thus fixing both in the respective positions in which they are secured.

As shown in FIGS. 3-5, the bowl 3 may also be secured at various angles and orientations with respect to both the base 2 and the counter by placing the bowl 3 in its desired position and angle and moving the bowl handle 92 to cause the suction device 15 to adhere to and fix the bowl 3 in that position.

Thus, one may fix the bowl 3 at a desired position and still move the base 2 to a different location; one may secure the base 2 to the counter and move the bowl 3 to a desired position or angle on the base 2; one may secure the bowl 3 to the base 2 and the base 2 to the counter at the same time; or one may leave both base 2 and bowl 3 unsecured and moveable.

Ingredients may be added to the bowl 3, mixed in the bowl 3, or added and mixed simultaneously in any of the above described configurations of the bowl 3 and base 2, allowing the cook or operator maximum flexibility in positioning and orienting the base 2 and bowl 3 for various mixing, adding, and stirring tasks.

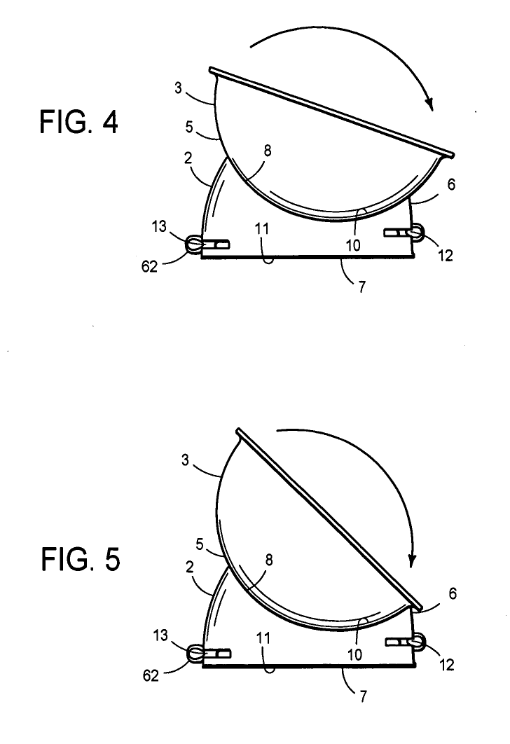

As shown in FIGS. 4 and 5, the various permitted orientations of the bowl 3 also allow ingredients to be added to the bowl 3 fixed at a desired angle; allow ingredients to be mixed in the bowl 3 while the bowl 3 is fixed at an optimum angle for such mixing; allow the base 2 and attached bowl 3 to be moved without changing or disturbing the angle or orientation of the bowl 3; and allow the operator or cook to add and mix ingredients with both hands at the same time, without having to hold on to or tend the bowl 3 or base 2 at all.

It is understood that while certain forms of this invention have been illustrated and described, it is not limited thereto except insofar as such limitations are included in the following claims and allowable functional equivalents thereof.

What is claimed is:

1. A mixing bowl assembly for use on a work surface, the mixing bowl assembly comprising:
(a) a mixing bowl;
(b) a base;
(c) a work surface suction device capable of securing the base to the work surface; and
(d) a bowl suction device capable of securing the mixing bowl to the base.

2. The mixing bowl assembly of claim 1 wherein the work surface suction device is housed in a chamber in the base.

3. The mixing bowl assembly of claim 1 wherein the work surface suction device is activated by moving a handle in one direction and deactivated by moving the handle in a another direction.

4. The mixing bowl assembly of claim 1 wherein the work surface suction device comprises
(a) a plate having an extension that forms a sloped surface spaced apart from the plate;
(b) a suction pad having a central portion mounted to the plate; and
(c) a handle that is slidable along the sloped surface of the extension of the plate to change a distance between the central portion of the suction pad and the work surface.

5. The mixing bowl assembly of claim 4 wherein sliding the handle in one direction increases the distance between the central portion of the suction pad and the work surface, and sliding the handle in another direction decreases the distance between the central portion of the suction pad and the work surface.

6. The mixing bowl assembly of claim 4 wherein, when the distance between the central portion of the suction pad and the work surface is increased, a partial vacuum is created therebetween, causing an outside portion of the suction pad to adhere to the work surface.

7. The mixing bowl assembly of claim 4 wherein, when the distance between the central portion of the suction pad and the work surface is decreased, the suction pad is relaxed, permitting the suction pad to be moved on and from the work surface.

8. The mixing bowl assembly of claim 1 wherein the bowl suction device is housed in a chamber in the base.

9. The mixing bowl assembly of claim 1 wherein the bowl suction device is activated by moving a handle in one direction and deactivated by moving the handle in a another direction.

10. The mixing bowl assembly of claim 1 wherein the bowl suction device comprises
(a) a plate having an extension that forms a sloped surface spaced apart from the plate;
(b) a suction pad having a central portion mounted to the plate; and
(c) a handle that is slidable along the sloped surface of the extension of the plate to change a distance between the central portion of the suction pad and a bottom portion of the mixing bowl.

11. The mixing bowl assembly of claim 10 wherein sliding the handle in one direction increases the distance between the central portion of the suction pad and the bottom portion of the bowl, and sliding the handle in another direction decreases the distance between the central portion of the suction pad and the bottom portion of the mixing bowl.

12. The mixing bowl assembly of claim 10 wherein, when the distance between the central portion of the suction pad and the bottom portion of the mixing bowl is increased, a partial vacuum is created therebetween, causing an outside portion of the suction pad to adhere to the mixing bowl.

13. The mixing bowl assembly of claim 10 wherein, when the distance between the central portion of the suction pad and the bottom portion of the mixing bowl is decreased, the suction pad is relaxed, permitting the mixing bowl to be moved on and from the suction pad.

14. A mixing bowl assembly comprising:
(a) a mixing bowl having a bottom portion;
(b) a base configured to receive the bottom portion of the mixing bowl; and
(c) a suction device in the base to secure the mixing bowl to the base.

15. The mixing bowl assembly of claim 14 wherein the suction device is activated by moving a handle in one direction and deactivated by moving the handle in a another direction.

16. The mixing bowl assembly of claim 14 wherein the suction device comprises
(a) a plate having an extension that forms a sloped surface spaced apart from the plate;
(b) a suction pad having a central portion connected to the plate;
(c) a handle slidable along the sloped surface of the extension to move the central portion of the suction pad toward and away from the bottom portion of the mixing bowl.

17. The mixing bowl assembly of claim 16 wherein, when the handle slides in one direction along the sloped surface, the central portion of the suction pad moves away from the bottom portion of the mixing bowl and an outer portion of the suction pad contacts the mixing bowl and secures the mixing bowl to the suction pad.

18. The mixing bowl assembly of claim 16 wherein, when the handle slides in one direction along the sloped surface, the central portion of the suction pad moves toward the bottom portion of the mixing bowl, and the bottom portion of the mixing bowl is removable from the suction pad.

19. A mixing bowl assembly for use on a work surface, the mixing bowl assembly comprising:
(a) a mixing bowl;
(b) a base configured to receive a bottom portion of the mixing bowl; and
(c) a suction device in the base to secure the mixing bowl to the base at selected angles with respect to the work surface.

20. A mixing bowl assembly for use on a work surface, the mixing bowl assembly comprising:
(a) a mixing bowl;
(b) a base configured to receive the mixing bowl;
(c) a work surface suction device capable of securing the base to the work surface; and
(d) a bowl suction device capable of securing the mixing bowl to the base at selected angles with respect to the work surface.

21. A mixing bowl assembly for use on a counter, the mixing bowl assembly comprising:
(a) a base containing a bowl suction device and a counter suction device;
(b) a mixing bowl adherable to the bowl suction device; and
(c) the counter suction device adherable to the counter

22. A method of using a mixing bowl assembly comprising;
(a) providing a base containing
(i) a bowl suction device to receive a mixing bowl; and
(ii a counter suction device to secure the mixing bowl to a work surface;
(b) securing at least one of
(i) the mixing bowl at a selected angle to the bowl suction device; and
(ii) the counter suction device to a selected location on the work surface.

23. The method of claim 22 including the steps of
(a) placing at least one ingredient in the mixing bowl; and
(b) mixing the at least one ingredient in the mixing bowl.

24. A method of using a mixing bowl assembly comprising:
(a) providing a base containing a suction device;
(b) placing a mixing bowl on the suction device at a selected angle;
(c) securing the mixing bowl to the suction device at the selected angle;
(d) placing at least one ingredient in the mixing bowl; and
(e) stirring the at least one ingredient in the mixing bowl.

25. A method of using a mixing bowl assembly comprising:
(a) providing a base containing a suction device securable to a mixing bowl by moving a handle;
(b) moving the handle in one direction to secure the mixing bowl to the suction device;
(c) placing ingredients in the mixing bowl;
(d) stirring the ingredients in the mixing bowl; and
(e) moving the handle in another direction to release the mixing bowl from the suction device.
